(19) United States
(12) Patent Application Publication
(10) Pub. No.: US 2012/0173181 A1
(43) Pub. Date: Jul. 5, 2012

(54) ELECTRONIC DEVICE AND METHOD FOR CONFIGURATING SETTING VALUES OF OSCILLOSCOPES

(75) Inventors: HSIEN-CHUAN LIANG, Tu-Cheng (TW); SHEN-CHUN LI, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/284,991

(22) Filed: Oct. 31, 2011

(30) Foreign Application Priority Data
Dec. 30, 2010 (TW) 099146779

(51) Int. Cl. G06F 19/00

(52) U.S. Cl. 702/85

(57) ABSTRACT

A method for configuring setting values of oscilloscopes selects manufactures for a first oscilloscope and a second oscilloscope, and sends a command of acquiring a type respectively to the first oscilloscope and the second oscilloscope using the control codes of the selected manufacturers, to determine if the selected manufactures are the actual manufacturer. The method sends a command of acquiring setting values, respectively to the first oscilloscope and the second oscilloscope, using the control codes of the selected manufacturers, receives and compares the setting values of the first oscilloscope and the second oscilloscope. The method changes the setting values of the second oscilloscope to be same or similar with the first oscilloscope, and writes the changed setting values into the second oscilloscope.

### BACKGROUND

1. Technical Field

Embodiments of the present disclosure relate to devices and methods of processing oscilloscope data, and more particularly to an electronic device and a method for configuring setting values of oscilloscopes.

2. Description of Related Art

Oscilloscopes are instruments for testing certain qualities of electronic signals, and indicating and recording test data including time-varying electrical quantities, such as current and voltage, of the electronic signals. The time-varying electrical quantities can help to evaluate the qualities of the electronic signals. Due to different setting values, such as, a trigger and a sample rate of acquiring electronic signals, a record length and a resolution of the acquired electronic signals.

Different oscilloscopes may test differently due to various factors. One oscilloscope may test data differently from another oscilloscopes, thus, it is hard to accurately reproduce the time-varying electrical quantities of an electronic signal on different oscilloscopes. In order to solve the reproduction of the time-varying electrical quantities of an electronic signal on different oscilloscopes, the setting values of different oscilloscopes need to be substantially synchronized. Although the setting values can be set manually, this is time-wasting.

### BRIEF DESCRIPTION OF THE DRAWINGS

FIG. 1 is a block diagram of one embodiment of an electronic device comprising an oscilloscope setting values configuration system.

FIG. 2 is a block diagram of one embodiment of function modules of the oscilloscope setting values configuration system of FIG. 1.

FIG. 3 is a flowchart of one embodiment of a method for configuring setting values of oscilloscopes.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

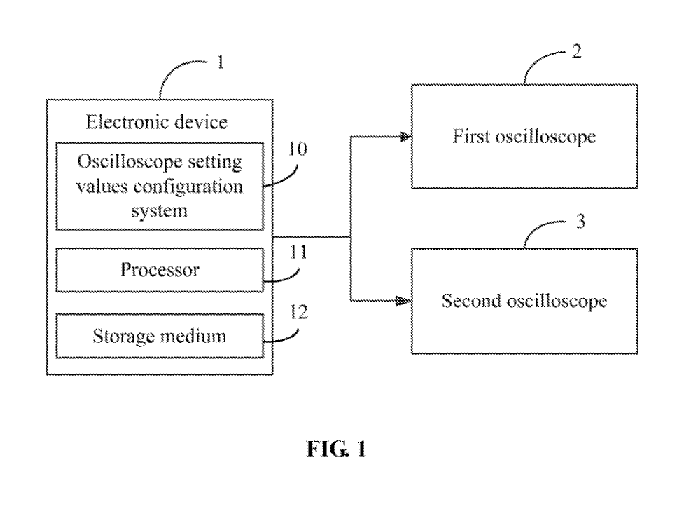

FIG. 1 is a block diagram of one embodiment of an electronic device 1 comprising an oscilloscope setting values configuration system 10. In the embodiment, the electronic device 1 further includes at least one processor 11 and a non-transitory storage medium (hereinafter, storage medium for short) 12. Depending on the embodiment, the storage medium 12 may be a hard disk drive, a compact disc, a digital video disc, a tape drive or other suitable storage medium.

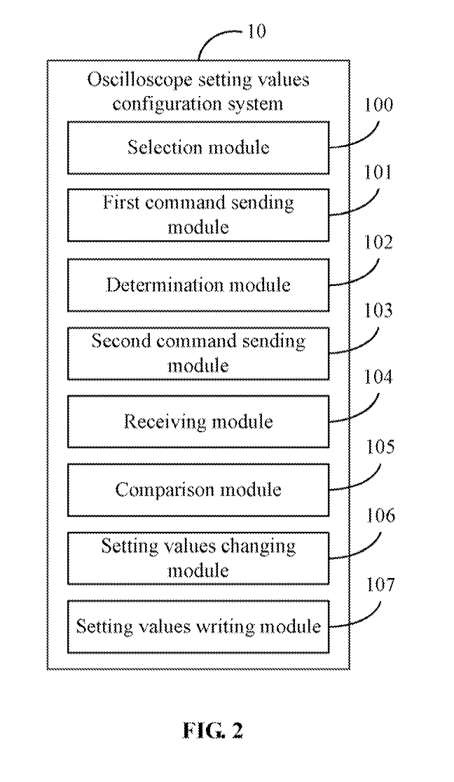

The oscilloscope setting values configuration system 10 includes a number of function modules (depicted in FIG. 2). The function modules may comprise computerized code in the form of one or more programs that are stored in the storage medium 12. The computerized code includes instructions that are executed by the at least one processor 11, to automatically compare setting values of a first oscilloscope 2 and of a second oscilloscope 3, which are both connected to the electronic device 1, generate a comparative difference table, and change the setting values of the second oscilloscope 3 to be same or similar with the setting values of the first oscilloscope 2, according to the comparative difference table. In one embodiment, the setting values may include, such as, a trigger and a sample rate of acquiring electronic signals, a record length and a resolution of the acquired electronic signals.

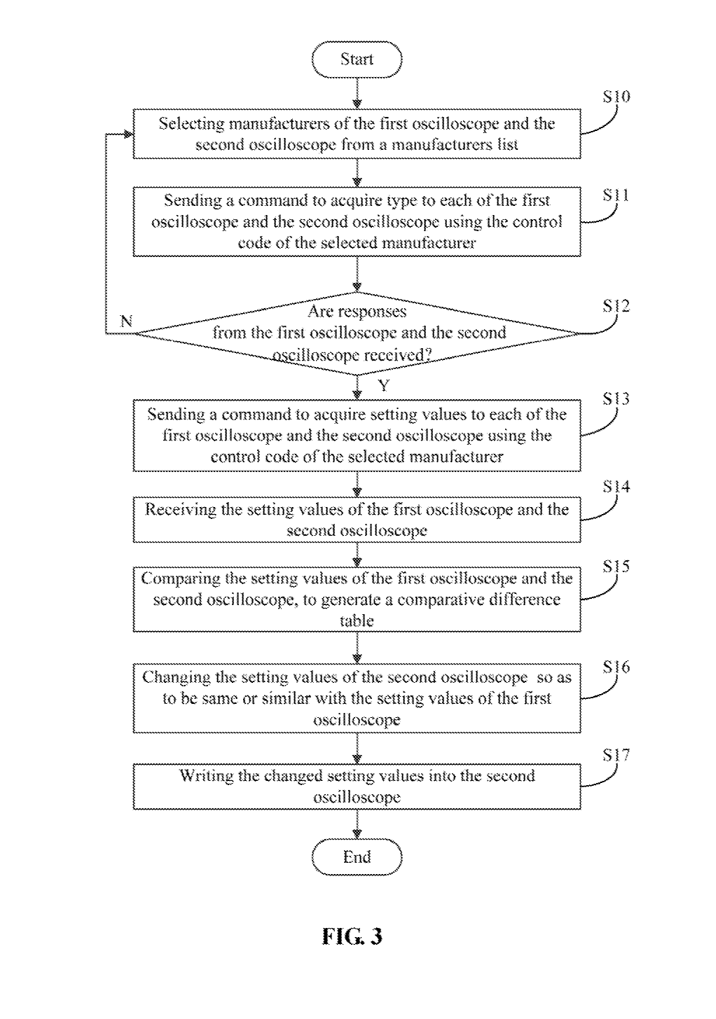

FIG. 2 is a block diagram of one embodiment of function modules of the oscilloscope setting values configuration system 10. In one embodiment, the oscilloscope setting values configuration system 10 may include a selection module 100, a first command sending module 101, a determination module 102, a second command sending module 103, a receiving module 104, a comparison module 105, an setting values changing module 106, and an setting values writing module 107. The function modules 100-107 may provide the functions illustrated in FIG. 3 in addition to any other functions.

FIG. 3 is a flowchart of one embodiment of a method for configuring setting values of oscilloscopes. Depending on the embodiment, additional blocks may be added, others removed, and the ordering of the blocks may be changed.

In block S10, the selection module 100 selects one or more manufacturers of the first oscilloscope 2 and the second oscilloscope 3 from a list of manufacturers (e.g., an electronic file, “the manufacturers list”). The manufacturers list may be pre-stored in the storage medium 12. In one embodiment, the selection may be at random.

In block S11, the first command sending module 101 sends first commands 3 to the first oscilloscope 2 and the second oscilloscope 3, using control codes provided by the selected manufacturer. The first command is about acquiring a respective instrument type of the first oscilloscope 2 or the second oscilloscope 3. It is understood that oscilloscopes made by different manufacturers can be controlled by different control codes.

In block S12, the determination module 102 determines if any response from the first oscilloscope 2 and the second oscilloscope 3 has been received. If both the first oscilloscope 2 and the second oscilloscope 3 respond to the respective first command, the selected manufacturer(s) are regarded as the actual manufacturer(s) of the first oscilloscope 2 and the second oscilloscope 3, and block S13 is implemented. If one of the two oscilloscopes does not respond to the respective first command, the selected manufacturer(s) is regarded as wrong, and block S10 is repeated to select another manufacturer(s).

In block S13, the second command sending module 103 sends second commands using the control codes provided by the corresponding manufacturer, to the first oscilloscope 2 and the second oscilloscope 3. The second command is about acquiring respective setting values of the first oscilloscope 2 and the second oscilloscope 3

In block S14, the receiving module 104 receives the setting values from the first oscilloscope 2 and the second oscilloscope 3.

In block S15, the comparison module 105 compares the setting values of the first oscilloscope 2 with the setting values of the second oscilloscope 3 to generate if necessary a comparative difference table (an electronic file). The comparative difference table may be stored in the storage medium 12.

In block S16, the setting values changing module 106 changes the setting values of the second oscilloscope 3 to be the same or similar with the setting values of the first oscilloscope 2, according to if required the comparative difference table. In another embodiment, the setting values changing module 106 may change the setting values of the first oscilloscope 2 to be the same or similar with the setting values of the second oscilloscope 3, according to if required the comparative difference table.

In block S17, the setting values writing module 107 writes the changed setting values into the second oscilloscope 3.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for configuring setting values of oscilloscopes, the method being performed by execution of computerized code by a processor of an electronic device, the method comprising:
selecting manufacturers of a first oscilloscope and a second oscilloscope from a manufacturers list;
sending a first command of acquiring an instrument type of the first oscilloscope or the second oscilloscope, respectively to the first oscilloscope and the second oscilloscope, using control codes provided by the selected manufacturers, to determine if the selected manufacturers of the first oscilloscope and the second oscilloscope are right;
sending a second command of acquiring setting values, to each of the first oscilloscope and the second oscilloscope, using the control codes provided by the selected manufacturers upon condition that both the selected manufacturers of the first oscilloscope and the second oscilloscope are right;
receiving the setting values from the first oscilloscope and the second oscilloscope;
comparing the setting values of the first oscilloscope with the setting values of the second oscilloscope, to generate a comparative difference table;
changing the setting values of the second oscilloscope to be the same or similar with the setting values of the first oscilloscope according to the comparative difference table; and
writing the changed setting values into the second oscilloscope.

2. The method according to claim 1, wherein the setting values comprise a trigger and a sample rate of acquiring electronic signals, a record length and a resolution of the acquired electronic signals.

3. The method according to claim 1, wherein the manufacturers list is pre-stored in a storage medium.

4. The method according to claim 1, wherein the selection of the manufacturers is at random.

5. The method according to claim 1, wherein if both the first oscilloscope and the second oscilloscope respond to the respective first command of acquiring the instrument type, the selected manufacturers of the first oscilloscope and the second oscilloscope are right.

6. The method according to claim 1, wherein the comparative difference table is stored in a storage medium.

7. A non-transitory storage medium having stored thereon instructions that, when executed by a processor of an electronic device, causes the processor to perform a method for configuring setting values of oscilloscopes, the method comprising:
selecting manufacturers of a first oscilloscope and a second oscilloscope from a manufacturers list;
sending a first command of acquiring an instrument type of the first oscilloscope or the second oscilloscope, respectively to the first oscilloscope and the second oscilloscope, using control codes provided by the selected manufacturers, to determine if the selected manufacturers of the first oscilloscope and the second oscilloscope are right;
sending a second command of acquiring setting values, to each of the first oscilloscope and the second oscilloscope, using the control codes provided by the selected manufacturers upon condition that both the selected manufacturers of the first oscilloscope and the second oscilloscope are right;
receiving the setting values from the first oscilloscope and the second oscilloscope;
comparing the setting values of the first oscilloscope with the setting values of the second oscilloscope, to generate a comparative difference table;
changing the setting values of the second oscilloscope to be the same or similar with the setting values of the first oscilloscope according to the comparative difference table; and
writing the changed setting values into the second oscilloscope.

8. The non-transitory storage medium according to claim 7, wherein the setting values comprise a trigger and a sample rate of acquiring electronic signals, a record length and a resolution of the acquired electronic signals.

9. The non-transitory storage medium according to claim 7, wherein the manufacturers list is pre-stored in the storage medium.

10. The non-transitory storage medium according to claim 7, wherein the selection of the manufacturers is at random.

11. The non-transitory storage medium according to claim 7 wherein if both the first oscilloscope and the second oscilloscope respond to the respective first command of acquiring the instrument type, the selected manufacturers of the first oscilloscope and the second oscilloscope are right.

12. The non-transitory storage medium according to claim 7, wherein the comparative difference table is stored in the storage medium.

13. An electronic device, comprising:
a non-transitory storage medium;
at least one processor; and
one or more modules that are stored in the non-transitory storage medium; and are executed by the at least one processor, the one or more modules comprising instructions:
to select manufacturers of a first oscilloscope and a second oscilloscope from a manufacturers list;
to send a first command of acquiring an instrument type of the first oscilloscope or the second oscilloscope, respectively to the first oscilloscope and the second oscilloscope, using control codes provided by the selected manufacturer, to determine if the selected manufacturers of the first oscilloscope and the second oscilloscope are right;
to send a second command of acquiring setting values, to each of the first oscilloscope and the second oscilloscope, using the control codes provided by the selected manufacturer upon condition that both the selected manufacturers of the first oscilloscope and the second oscilloscope are right;
to receive the setting values from the first oscilloscope and the second oscilloscope;
to compare the setting values of the first oscilloscope with the setting values of the second oscilloscope, to generate a comparative difference table;
to change the setting values of the second oscilloscope to be the same or similar with the setting values of the first oscilloscope according to the comparative difference table; and
to write the changed setting values into the second oscilloscope.

14. The electronic device according to claim 13, wherein the setting values comprise a trigger and a sample rate of acquiring electronic signals, a record length and a resolution of the acquired electronic signals.

15. The electronic device according to claim 13, wherein the manufacturers list is pre-stored in the storage medium.

16. The electronic device according to claim 13, wherein the selection of the manufacturers is at random.

17. The electronic device according to claim 13, wherein if both the first oscilloscope and the second oscilloscope respond to the respective first command of acquiring the instrument type, the selected manufacturers of the first oscilloscope and the second oscilloscope are right.

18. The electronic device according to claim 13, wherein the comparative difference table is stored in the storage medium.
